(19) United States
(12) Patent Application Publication
(10) Pub. No.: US 2021/0192453 A1
(43) Pub. Date: Jun. 24, 2021

(54) SYSTEM AND METHOD FOR IDENTIFYING SUPPLY CHAIN ISSUES

(71) Applicant: CARRIER CORPORATION, Palm Beach Gardens, FL (US)

(72) Inventor: Mihir SHAH, The Hague (NL)

(21) Appl. No.: 17/252,938

(22) PCT Filed: Nov. 26, 2019
(86) PCT No.: PCT/US2019/063211

§ 371 Date: Dec. 16, 2020

Related U.S. Application Data
(60) Provisional application No. 62/782,600, filed on Dec. 20, 2018.

(51) Int. Cl. G06Q 10/08; G06N 7/00

(52) U.S. Cl. CPC G06Q 10/08355; G06N 7/005

(57) ABSTRACT

A method of analyzing a supply chain includes determining a plurality of characteristics of each of a plurality of shipments; determining, for each trip, whether any of the characteristics indicates or corresponds to an identified issue that is one of a plurality of predetermined issues. For each identified issue, a probability is determined whether the identified issue will occur on a future shipment based on information regarding the determined characteristics from the shipment including the identified issue and other shipments having corresponding characteristics. A determination is made which of the plurality of predetermined issues are most likely to occur during a future shipment based on the determined probabilities.

### CROSS REFERENCE TO RELATED APPLICATIONS

This application claims priority to U.S. Provisional Application No. 62/782,600, which was filed on Dec. 20, 2018, and is incorporated herein by reference.

### BACKGROUND

Various factors affect performance and results during transit including the tendencies of a carrier or shipping company and the conditions along a shipment route. Some aspects of shipper performance may have an adverse effect on the shipped items in some cases. The reasons why some shipments are successful or satisfactory and others are not can be varied and complex.

While various proposals have been made and various products or services are available to monitor the conditions of a vehicle or within a shipping container during a shipment most of them merely provide information as a basic or straightforward report of the measured conditions. None of them provide information about broader trends regarding issues that can arise among different shipments or different shipping companies.

### SUMMARY

An illustrative example embodiment of a method of analyzing a supply chain includes determining a plurality of characteristics of each of a plurality of shipments. The characteristics of each shipment include an identity of at least one carrier from a plurality of known carriers, an indication of cargo within at least one shipping container, an origin and a destination of the shipment, a distance between the origin and the destination, a number of stops between the origin and the destination, a duration between a beginning time and a completion time of the shipment, and at least one other characteristic indicative of a performance or condition of the at least one container during the shipment. For each of the shipments, the method includes determining whether any of the characteristics indicates or corresponds to an identified issue that is one of a plurality of predetermined issues. For each identified issue, a probability is determined whether the identified issue will occur on a future shipment based on information regarding the determined characteristics from at least one of the shipments that includes the identified issue and information regarding corresponding characteristics of others of the plurality of shipments. A determination is made which of the plurality of predetermined issues are most likely to occur during a future shipment based on the determined probabilities.

In an example embodiment having one or more features of the method of the previous paragraph, determining the probability for each identified issue is based on a combination of the characteristics of the shipment that included the identified issue and characteristics of others of the shipments that include the same characteristic that indicates or corresponds to the identified issue.

An example embodiment having one or more features of the method of any of the previous paragraphs includes determining which of the plurality of predetermined issues are most likely to occur for each of the origins and each of the destinations.

An example embodiment having one or more features of the method of any of the previous paragraphs includes determining which of the origins and which of the destinations is most likely to be associated with at least one of the predetermined issues.

An example embodiment having one or more features of the method of any of the previous paragraphs includes determining which of the plurality of predetermined issues are most likely to occur for each of the plurality of carriers.

An example embodiment having one or more features of the method of any of the previous paragraphs includes determining which of the plurality of carriers is most likely to experience at least one of the predetermined issues.

An example embodiment having one or more features of the method of any of the previous paragraphs includes determining which of the plurality of predetermined issues are most likely to occur based on at least one of the duration, beginning time or completion time of the future shipment.

In an example embodiment having one or more features of the method of any of the previous paragraphs, the container used for at least some of the shipments is a temperature-controlled container, the plurality of determined characteristics includes a temperature within the temperature-controlled container during the at least some of the shipments, and the predetermined issues include at least one issue based on the temperature within the temperature-controlled container.

In an example embodiment having one or more features of the method of any of the previous paragraphs, determining the probability for each identified issue is based on multiple combinations of respective ones of the carriers, respective ones of the origins, respective ones of the destinations, respective ones of the expected distances, respective ones of the expected numbers of stops, and respective ones of the durations.

In an example embodiment having one or more features of the method of any of the previous paragraphs, determining the probability for each identified issue is based on all combinations of the carriers, the origins, the destinations, the expected distances, the expected numbers of stops and the durations.

An illustrative example system for analyzing a supply chain, which includes a plurality of carriers that respectively complete a plurality of shipments, includes a processor and a database associated with the processor. The processor is configured to determine a plurality of characteristics of each of the plurality of shipments; provide the determined characteristics for each trip to the database, wherein the database stores the determined characteristics; determine, for each of the shipments, whether any of the characteristics indicates or corresponds to an identified issue that is one of a plurality of predetermined issues; determine, for each identified issue, a probability that the identified issue will occur on a future shipment based on information from the database regarding the determined characteristics from at least one of the shipments that includes the identified issue and information from the database regarding corresponding characteristics of others of the plurality of shipments; provide the determined probabilities to the database, wherein the database stores the determined probabilities; and determine which of the plurality of predetermined issues are most likely to occur during a future shipment based on the determined probabilities. The characteristics of each shipment include an identity of at least one of the carriers completing the shipment, an indication of cargo within at least one shipping container during the shipment, an origin and a destination of the shipment, a distance traveled between the origin and the destination, a number of stops between the origin and the destination, a duration between a beginning time and a completion time of the shipment, and at least one other characteristic indicative of a performance or condition of the at least one container during the shipment.

In an example embodiment having one or more features of the system of the previous paragraph, the processor is configured to determine the probability for each identified issue based on a combination of the characteristics of the shipment that included the identified issue and characteristics of others of the shipments that include the same characteristic that indicates or corresponds to the identified issue.

In an example embodiment having one or more features of the system of any of the previous paragraphs, the processor is configured to determine which of the plurality of predetermined issues are most likely to occur for each of the origins and each of the destinations.

In an example embodiment having one or more features of the system of any of the previous paragraphs, the processor is configured to determine which of the origins and which of the destinations is most likely to be associated with at least one of the predetermined issues.

In an example embodiment having one or more features of the system of any of the previous paragraphs, the processor is configured to determine which of the plurality of predetermined issues are most likely to occur for each of the plurality of carriers.

In an example embodiment having one or more features of the system of any of the previous paragraphs, the processor is configured to determine which of the plurality of carriers is most likely to experience at least one of the predetermined issues.

In an example embodiment having one or more features of the system of any of the previous paragraphs, the processor is configured to determine which of the plurality of predetermined issues are most likely to occur based on at least one of the duration, beginning time or completion time of the future shipment.

In an example embodiment having one or more features of the system of any of the previous paragraphs, the container used for at least some of the shipments is a temperature-controlled container; the plurality of determined characteristics includes a temperature within the temperature-controlled container during the at least some of the shipments; and the predetermined issues include at least one issue based on the temperature within the temperature-controlled container.

In an example embodiment having one or more features of the system of any of the previous paragraphs, the processor is configured to determine the probability for each identified issue based on multiple combinations of respective ones of the carriers, respective ones of the origins, respective ones of the destinations, respective ones of the expected distances, respective ones of the expected numbers of stops, and respective ones of the durations.

In an example embodiment having one or more features of the system of any of the previous paragraphs, the processor is configured to determine the probability for each identified issue based on all combinations of the carriers, the origins, the destinations, the expected distances, the expected numbers of stops and the durations.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates a system designed according to an embodiment of this invention.

FIG. 2 is a flow chart diagram summarizing an example method designed according to an embodiment of this invention.

### DETAILED DESCRIPTION

Embodiments of this invention provide information regarding a supply chain that includes multiple shippers and a variety of shipments. Embodiments of this invention allow for identifying the most significant or highest impact issues that may affect potential shipments based on information regarding previous shipments and determined probabilities that such issues may occur.

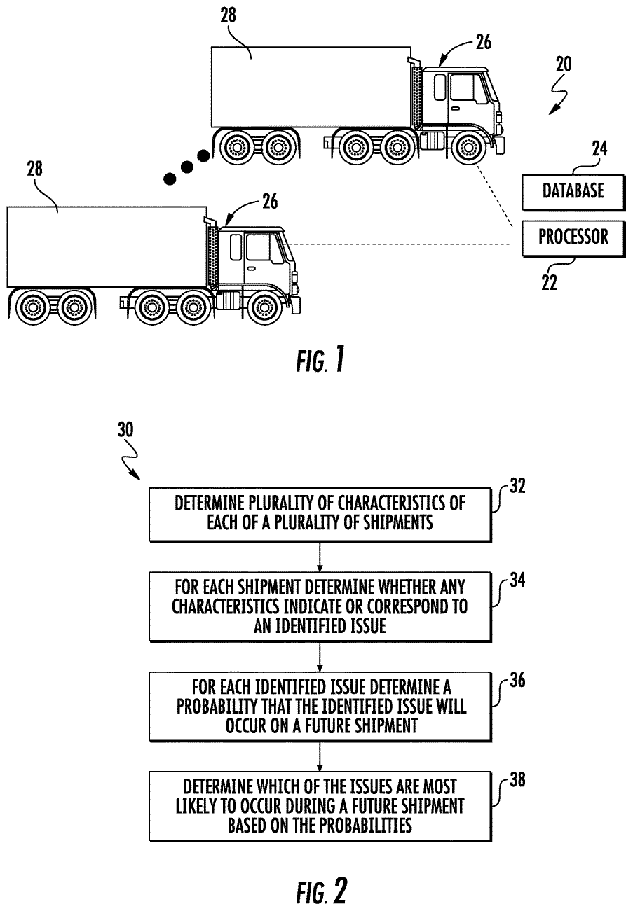

FIG. 1 schematically illustrates a system 20 for analyzing a supply chain. A processor 22 comprises one or more computing devices that are configured, through programming for example, to perform analysis regarding a plurality of carriers or shipping companies and a variety of shipments. A database 24 is associated with the processor 22. The database 24 includes information regarding characteristics of previous shipments and results of analyses completed by the processor 22.

As schematically shown in FIG. 1, the processor 22 gathers information regarding shipments completed by carriers using vehicles 26, which are illustrated as trucks for discussion purposes. Each shipment includes cargo within at least one shipping container 28, such as a truck trailer. In some instances, the shipping container 28 is a temperature-controlled container that includes a refrigeration unit (not illustrated) to maintain a desired temperature within the container 28 to establish desired conditions for the cargo within the container 28.

FIG. 2 is a flow chart diagram 30 summarizing an example technique of analyzing a supply chain. At 32, the processor 22 determines a plurality of characteristics of each of a plurality of shipments. The characteristics of each shipment include an identity of at least one carrier completing the shipment. The supply chain in this example includes multiple, known shippers and the processor 22 obtains information regarding the shipper for a particular shipment in one of several ways. For example, communications between the processor 22 and a vehicle 26 may include a vehicle or shipper identifier. Alternatively, the processor 22 is provided with information regarding a schedule of shipments, which includes identifiers of the respective carriers for each shipment.

The characteristics of each shipment also include an indication of cargo within the shipping container 28 of that shipment. In some instances, the cargo has particular requirements during shipment and the determined characteristics relate to or indicate a performance or condition of the shipping container 28 during such a shipment. For example, when the cargo must be refrigerated, the determined characteristics include temperature information regarding the interior of the shipping container 28 at various times during the shipment.

The characteristics determined at 32 for each shipment include an origin and a destination of the shipment, and a distance between the origin and the destination traveled during the shipment, and a number of stops between the origin and the destination. The determined characteristics also include a duration or elapsed time between a beginning time and a completion time of the shipment.

Other determined characteristics indicate or relate to a performance or condition of the shipping container 28. Such characteristics include, for example, pre-cooling parameters and periods of time or a number of times that the shipping container is open from a time when the cargo has been placed in the container until the cargo has been removed at the destination.

At 34, the processor 22 determines whether any characteristics of each of the shipments indicates or corresponds to an identified issue that is one of a plurality of predetermined issues. For example, the database 24 includes a listing of a number of predetermined, potential issues that may affect a shipment. Examples of such issues include route distances that differ from an expected distance, delays in shipment, numbers of stops that differ from an expected number of stops for a particular shipment, delays or damage that occurs at a particular origin location or destination location, and differences between a temperature within the shipping container 28 and a desired temperature for the particular cargo during the shipment. The determination at 34 relates specific characteristics to particular issues. For example, the number of times a shipping container is opened can relate to issues regarding potential theft or inefficient performance of a refrigeration system. The number of stops or duration of time between the beginning and completion of a shipment relate to issues regarding shipping delays. The processor 22 is programmed or otherwise configured to identify when one of the predetermined issues occurred during a shipment based on the related or corresponding characteristics of that shipment.

Each time the processor 22 identifies one of the issues occurred or was implicated during a shipment, the processor 22 determines a probability that the identified issue will occur on a future shipment at 36. Determining the probability at 36 is based upon information regarding the determined characteristics from the shipment that includes the identified issue and information regarding corresponding characteristics of others of the plurality of shipments whose characteristics are stored in the database 24.

In an example embodiment, determining the probability for each identified issue is based on a combination of the characteristics of the shipment that included the identified issue and characteristics of other shipments that include the same characteristic that indicates or corresponds to the identified issue.

For example, the processor 22 may determine that a particular shipment took longer than expected. By comparing other shipments between the same origin and destination, the processor 22 is able to make a determination regarding a probability that a future shipment between that origin and destination will involve a delay. This determination can be specific to each carrier within the supply chain. For example, the processor may determine a probability whether any or each of the carriers will experience such a delay. If the delay on a particular shipment is an anomaly compared to all other similar shipments recorded in the database 24, the probability of a delay in a future shipment is relatively low. If, on the other hand, the processor 22 determines that one or more of the carriers has experienced the same or a similar delay on multiple shipments between the same origin and destination, the processor determines a higher probability that such a delay will occur on a future shipment.

One aspect of the probability determination at 36 in FIG. 2 is that the processor 22 considers a variety of the characteristics that may have an impact on the particular issue. For example, the route taken by one carrier may differ from the route taken by another even though the origin and destination locations are the same. It is also possible that the receiving company at the destination location introduces a delay that is outside of the control of the shipper. The particular cargo or amount of cargo may also have an impact on whether a delay occurred. The processor 22 is programmed to account for a variety of different influences on the results of the shipment when determining the probability whether an issue will occur during a future shipment.

According to an example embodiment, the processor 22 determines a probability P_{R} of an issue occurring based on combinations of issues that may be experienced. The probability P_{R} may be determined according to the following equations.

$${P}_{R} = ( {\sum }_{j = 1}^{α} P ( j ) ) + ( {P}_{o} ) / {ω}_{o}$$

$${P}_{j} = \frac{{\sum }_{i = 1}^{m} {ω}_{o} \times ( ( {\sum }_{K = 1}^{{n}_{m}} {F}_{m} ( n ) / {n}_{m} )}{{\sum }_{i = 1}^{m} {ω}_{m}}$$

where: Pₒ are general probabilities of variables such as weather indications, ambient temperature or product condition;
ω is a weight assigned to an issue;
Fₘ is the probability function for a combination of issues;
n is the total shipments for each combination of issues; and
m is the total issues experienced for the analysis set, which may be a selection or the entire supply chain (with m having repeat issues based on different grouping criteria such as cooling issues per product, cooling issues per carrier, or cooling issues generally with differing weights).

At 38, the processor 22 determines which of the issues are most likely to occur during a future shipment based on the probabilities regarding the different identified issues from the shipments that are already stored in the database 24. The processor 22 accomplishes this by analyzing multiple combinations of the various characteristics of the shipments. For example, the processor 22 may consider all carriers combined with all origin and destination locations, all shipped products and all beginning and ending times of shipments. In some embodiments, the processor 22 analyzes all possible combinations of all characteristics from shipments that are determined to have at least some features in common. As a result of the determination at 38, the processor 22 provides an output that indicates which issues are most likely to occur. Such information allows a manufacturer or other customer of the shipping companies to select an option that appears the best for their circumstances.

Such information is not only useful to manufacturers or customers of the shipping companies, but is also useful to the shipping companies, themselves, for identifying problems or weaknesses within the supply chain so that corrective action can be taken where needed or desired.

An example embodiment includes providing an output that indicates information such as which carrier has the highest potential for taking a longer route, which origin location includes a high potential for pre-cooling issues, which destination location has a high potential for associated arrival spikes in temperature, which origin locations have a high potential for delayed shipments, and which carrier has a high probability of more than an average number of stops. Other or different information is included in the output of some embodiments. The output from the processor 22 in some embodiments includes probability information regarding combinations of characteristics, such as which combinations of carrier, origin, and destination have a high potential for the occurrence of one or more issues.

Some embodiments include determining not only which of the issues is most likely to occur for each of the plurality of carriers, but also determining which of the carriers is most likely to experience at least one of the predetermined issues. Similarly, some embodiments include determining which of the predetermined issues are most likely to occur for each origin location and each destination along with determining which of the origins and which of the destinations is most likely to be associated with at least one of the predetermined issues.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A method of analyzing a supply chain, the method comprising:
determining a plurality of characteristics of each of a plurality of shipments, wherein the characteristics of each shipment include
an identity of at least one carrier from a plurality of known carriers,
an indication of cargo within at least one shipping container,
an origin and a destination of the shipment,
a distance traveled between the origin and the destination,
a number of stops between the origin and the destination,
a duration between a beginning time and a completion time of the shipment, and
at least one other characteristic indicative of a performance or condition of the at least one container during the shipment;
determining, for each of the shipments, whether any of the characteristics indicates or corresponds to an identified issue that is one of a plurality of predetermined issues;
determining, for each identified issue, a probability that the identified issue will occur on a future shipment based on information regarding the determined characteristics from at least one of the shipments that includes the identified issue and information regarding corresponding characteristics of others of the plurality of shipments; and
determining which of the plurality of predetermined issues are most likely to occur during a future shipment based on the determined probabilities.

2. The method of claim 1, wherein determining the probability for each identified issue is based on a combination of the characteristics of the shipment that included the identified issue and characteristics of others of the shipments that include the same characteristic that indicates or corresponds to the identified issue.

3. The method of claim 1, comprising determining which of the plurality of predetermined issues are most likely to occur for each of the origins and each of the destinations.

4. The method of claim 3, comprising determining which of the origins and which of the destinations is most likely to be associated with at least one of the predetermined issues.

5. The method of claim 1, comprising determining which of the plurality of predetermined issues are most likely to occur for each of the plurality of carriers.

6. The method of claim 5, comprising determining which of the plurality of carriers is most likely to experience at least one of the predetermined issues.

7. The method of claim 1, comprising determining which of the plurality of predetermined issues are most likely to occur based on at least one of the duration, beginning time or completion time of the future shipment.

8. The method of claim 1, wherein
the container used for at least some of the shipments is a temperature-controlled container;
the plurality of determined characteristics includes a temperature within the temperature-controlled container during the at least some of the shipments; and
the predetermined issues include at least one issue based on the temperature within the temperature-controlled container.

9. The method of claim 1, wherein determining the probability for each identified issue is based on multiple combinations of
respective ones of the carriers,
respective ones of the origins,
respective ones of the destinations,
respective ones of the expected distances,
respective ones of the expected numbers of stops, and
respective ones of the durations.

10. The method of claim 9, wherein determining the probability for each identified issue is based on all combinations of the carriers, the origins, the destinations, the expected distances, the expected numbers of stops and the durations.

11. A system for analyzing a supply chain that includes a plurality of carriers that respectively complete a plurality of shipments, the system comprising a processor and a database associated with the processor, the processor being configured to
determine a plurality of characteristics of each of the plurality of shipments, wherein the characteristics of each shipment include
an identity of at least one of the carriers completing the shipment,
an indication of cargo within at least one shipping container during the shipment,
an origin and a destination of the shipment,
a distance traveled between the origin and the destination,
a number of stops between the origin and the destination,
a duration between a beginning time and a completion time of the shipment, and
at least one other characteristic indicative of a performance or condition of the at least one container during the shipment;
provide the determined characteristics for each trip to the database, wherein the database stores the determined characteristics;
determine, for each of the shipments, whether any of the characteristics indicates or corresponds to an identified issue that is one of a plurality of predetermined issues;
determine, for each identified issue, a probability that the identified issue will occur on a future shipment based on information from the database regarding the determined characteristics from at least one of the shipments that includes the identified issue and information from the database regarding corresponding characteristics of others of the plurality of shipments;
provide the determined probabilities to the database, wherein the database stores the determined probabilities; and
determine which of the plurality of predetermined issues are most likely to occur during a future shipment based on the determined probabilities.

12. The system of claim 11, wherein the processor is configured to determine the probability for each identified issue based on a combination of the characteristics of the shipment that included the identified issue and characteristics of others of the shipments that include the same characteristic that indicates or corresponds to the identified issue.

13. The system of claim 11, wherein the processor is configured to determine which of the plurality of predetermined issues are most likely to occur for each of the origins and each of the destinations.

14. The system of claim 13, wherein the processor is configured to determine which of the origins and which of the destinations is most likely to be associated with at least one of the predetermined issues.

15. The system of claim 11, wherein the processor is configured to determine which of the plurality of predetermined issues are most likely to occur for each of the plurality of carriers.

16. The system of claim 15, wherein the processor is configured to determine which of the plurality of carriers is most likely to experience at least one of the predetermined issues.

17. The system of claim 11, wherein the processor is configured to determine which of the plurality of predetermined issues are most likely to occur based on at least one of the duration, beginning time or completion time of the future shipment.

18. The system of claim 11, wherein
the container used for at least some of the shipments is a temperature-controlled container;
the plurality of determined characteristics includes a temperature within the temperature-controlled container during the at least some of the shipments; and
the predetermined issues include at least one issue based on the temperature within the temperature-controlled container.

19. The system of claim 11, wherein the processor is configured to determine the probability for each identified issue based on multiple combinations of
respective ones of the carriers,
respective ones of the origins,
respective ones of the destinations,
respective ones of the expected distances,
respective ones of the expected numbers of stops, and
respective ones of the durations.

20. The system of claim 19, wherein the processor is configured to determine the probability for each identified issue based on all combinations of the carriers, the origins, the destinations, the expected distances, the expected numbers of stops and the durations.
